(19) United States
(12) Patent Application Publication
(10) Pub. No.: US 2026/0179591 A1
(43) Pub. Date: Jun. 25, 2026

(54) PANEL, ELECTRONIC MUSICAL INSTRUMENT, AND ELECTRONIC DEVICE

(71) Applicant: CASIO COMPUTER CO., LTD., Tokyo (JP)

(72) Inventors: Naoto IMAMURA, Tokyo (JP); Chihiro SUZUKI, Tokyo (JP); Shuhei NAKAMURA, Tokyo (JP)

(21) Appl. No.: 19/424,561

(22) Filed: Dec. 18, 2025

(30) Foreign Application Priority Data
Dec. 19, 2024 (JP) 2024-224440

(51) Int. Cl. G10H 1/00; G02F 1/01; G10H 1/34

(52) U.S. Cl. CPC G10H 1/0008; G02F 1/0105; G10H 1/34; G10H 2220/061; G10H 2220/096; G10H 2220/411; G10H 2230/065

(57) ABSTRACT

A panel including: a base layer including a transmittable portion that transmits visible light and is shaped in a shape, and a base portion that surrounds the transmittable portion and has a lower transmittance of visible light than the transmittable portion; a first coloring layer that is on a layer above the base layer, is colored by a color, and transmits at least part of visible light; a diffuse reflection layer that is on a layer above the first coloring layer and diffusely reflects at least part of visible light; and a second coloring layer that is formed on a layer above the diffuse reflection layer or inside the diffuse reflection layer and, in plan view from above, formed inside the shape.

### REFERENCE TO RELATED APPLICATIONS

This application is based upon and claims the benefit of priority from the prior Japanese Patent Application No. 2024-224440, filed on December 19, 2024, the entire contents of which are incorporated herein by reference.

### TECHNICAL FIELD

The present disclosure relates to a panel, an electronic musical instrument, and an electronic device.

### DESCRIPTION OF RELATED ART

Conventional panels are known to illuminate and display letters, figures, symbols, etc. on the front surface by emitting light from a light source to the back surface side. Acrylic panels are used as panels (see, for example, JP 2023-180403 A).

### SUMMARY OF THE INVENTION

A panel reflecting one aspect of the present disclosure comprises: a base layer including a transmittable portion that transmits visible light and is shaped in a shape, and a base portion that surrounds the transmittable portion and has a lower transmittance of visible light than the transmittable portion; a first coloring layer that is on a layer above the base layer, is colored by a color, and transmits at least part of visible light; a diffuse reflection layer that is on a layer above the first coloring layer and diffusely reflects at least part of visible light; and a second coloring layer that is formed on a layer above the diffuse reflection layer or inside the diffuse reflection layer and, in plan view from above, formed inside the shape.

### BRIEF DESCRIPTION OF DRAWINGS

FIG. 1 is an overall perspective view of an electronic keyboard instrument in an embodiment.

FIG. 2 is a top view of an operation panel of FIG. 1.

FIG. 3 is an A-A´ cross-sectional view of the operation panel in FIG. 1.

FIG. 4 is a perspective view schematically showing each layer constituting a board in FIG. 3.

FIG. 5 is a view schematically showing the signage when a light emitter is caused to emit light in the operation panel of FIG. 1.

### DETAILED DESCRIPTION

The following is a description of forms for implementing the present disclosure, with the aid of drawings. However, the embodiments described below are subject to various limitations that are technically preferred for implementing the present disclosure. Therefore, the technical scope of this disclosure is not limited to the following embodiments and illustrative examples.

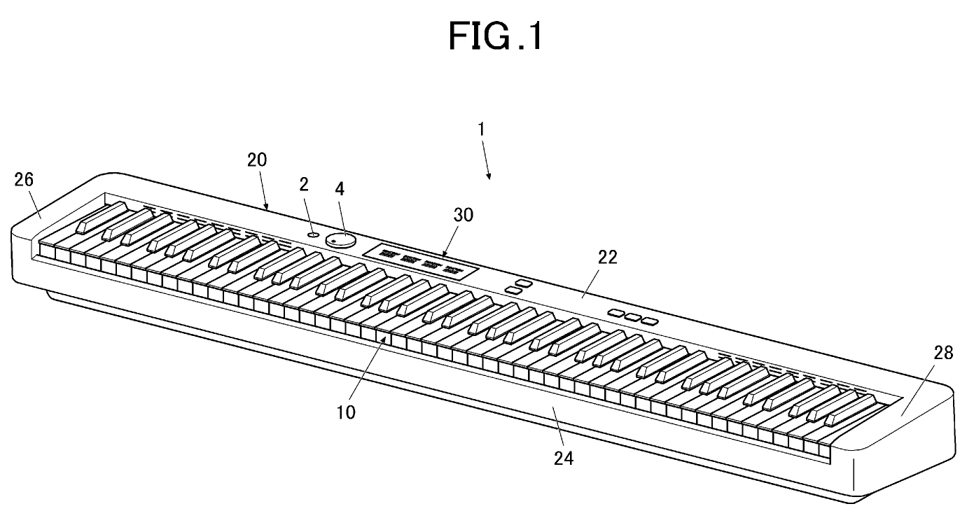

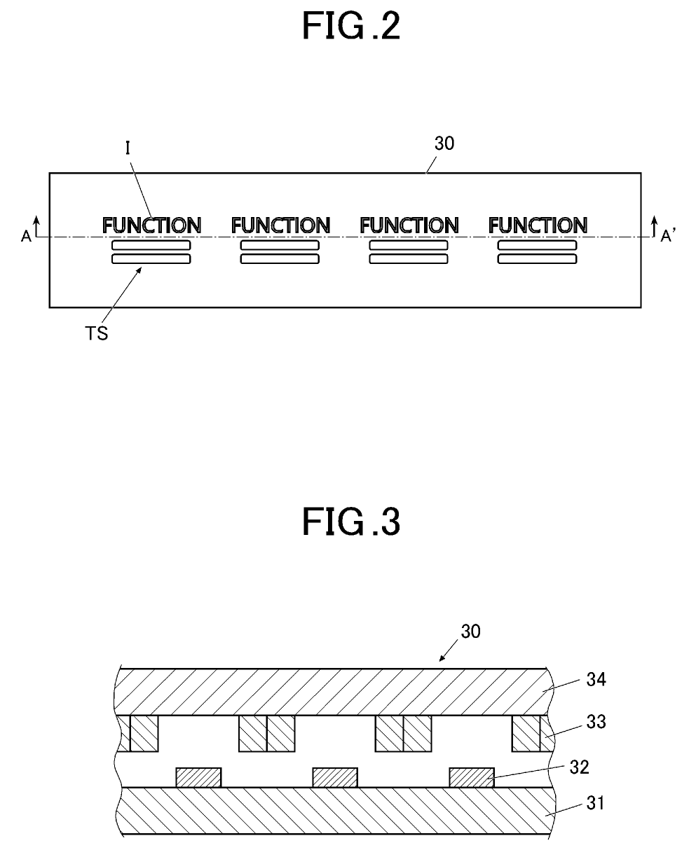

The electronic keyboard instrument (electronic musical instrument) 1 shown in FIG. 1 has a keyboard 10 having multiple keys (performance operators) such as white keys and black keys, and a case 20. Inside the case 20, control boards and other components are stored. In the following, the direction of the arrangement of the multiple keys of the electronic keyboard instrument 1 will be described as the left-right direction (the left side of the keyboard 10 in FIG. 1 is the left direction), the front-back direction of each key will be described as the front-back direction (the front side of the keyboard 10 in FIG. 1 is the front direction), and the up-down direction of the electronic keyboard instrument 1 will be described as the up-down direction. FIGS. 1 and 2 are shown as line drawings, and the addition of color is omitted.

The case 20 is a horizontal substantially rectangular shape with the left-right direction as the longitudinal direction of the entire keyboard in plan view from above, and has an upper case 22, a lower case 24, a left case 26, and a right case 28.

On the top surface of the upper case 22, there is a power button 2 for turning on/off the electronic keyboard instrument 1, a volume knob 4 for controlling the volume of the musical notes, and an operation panel 30 (panel). The electronic keyboard instrument 1 is equipped with a processor. When the power is turned on and the instrument starts up, the processor controls the operation panel 30 to light up.

As shown in FIG. 2, the operation panel 30 is equipped with multiple touch switches TS. The touch switches TS are capacitance switches for executing various functions related to the electronic keyboard instrument 1, and various operations such as demo performance, tone, brightness change, etc. are assigned to them. Each touch switch TS is provided with a sign I representing symbols or letters indicating the role of the touch switch TS, such as "FUNCTION" and an equal sign-shaped figure indicating the location of the touch switch TS. In FIG. 2, all are referred to as "FUNCTION" for convenience, but each function may have a different name (sign I).

As shown in FIG. 3, the operation panel 30 has, roughly in order from the lower side (back side), a circuit board 31, a light emitter 32 arranged on the circuit board 31, a detector 33, and a board 34. The circuit board 31 has a horizontal substantially rectangular shape that extends over the substantially entire area of the operation panel 30. Various types of wiring are routed to the circuit board 31, which is not shown in the figure. On the top surface of the circuit board 31, in the area corresponding to each touch switch TS in the up-down direction, there is a light emitter 32 that emits light (visible light) upward (i.e., to the board 34). The light emitter 32 is composed of, for example, LEDs (Light Emitting Diodes) and emits light from the back surface (from the lower side) to the board 34 via the detector 33. It is preferable that, around the light emitter 32, there is a reflective case, not shown, that exhibits reflectivity to the light from the light emitter 32.

The detector 33 is, for example, a capacitive touch sensor and includes a metal plate that constitutes the electrode of the touch sensor in substantially an annular shape with an opening in the center (not shown in the figure). When a touch operation is performed at each touch switch TS (when the user's finger contacts or comes close to it), the capacitance of the sheet metal member that is the electrode changes in the detector 33. The detector 33 detects this change in capacitance and sends a detection signal to the processor of the electronic keyboard instrument 1. The processor of the electronic keyboard instrument 1 executes the function corresponding to the touched touch switch TS according to this detection signal.

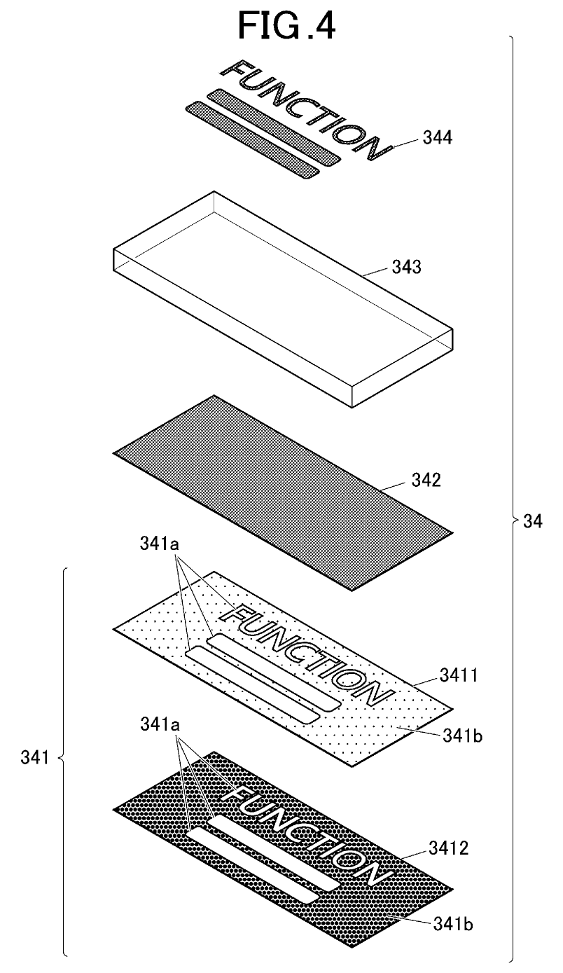

The base board of the board 34 (diffuse reflection layer 343 in FIG. 4) is, for example, a matted acrylic board that has a matte finish on its front surface and diffusely reflects at least part of the visible light. If the top surface of the operation panel is a glossy acrylic panel that has not been matted, fingerprints will stand out and reduce the appearance of the panel. Therefore, in this embodiment, the base board of the board 34 is a matted acrylic board to provide a good-looking operation panel 30 that is inconspicuous of fingerprints. However, if the acrylic board of the board 34 is made matted, light from the light emitter 32 will be difficult to penetrate, and if the configuration for displaying signs I by transmitting light emitted from below, as described in JP 2023-180403 A, for example, is applied as is, the visibility of complicated signs I such as letters will be poor.

Therefore, as shown in FIG. 4, the board 34 in this embodiment consists of a base layer 341, a first coloring layer 342, a diffuse reflection layer 343, and a second coloring layer 344, in order from the lower side (back side).

As mentioned above, the diffuse reflection layer 343 is composed of a matted acrylic board, which is the base board of the board 34. On the lower side (back side) of the diffuse reflection layer 343, the first coloring layer 342 and the base layer 341 are stacked. The first coloring layer 342 is colored by a certain color and transmits at least part of visible light. The color of the first coloring layer 342 is the principal color visible on the front surface of the operation panel 30. The first coloring layer 342 is formed, for example, by printing on the back side of the diffuse reflection layer 343.

The base layer 341 is formed under the first coloring layer 342. The base layer 341 has a transmittable portion 341a that transmits visible light and is shaped in a certain shape, and a base portion 341b that surrounds the transmittable portion 341a and has a lower transmittance of visible light than the transmittable portion 341a. The transmittable portion 341a is shaped in the shape of the sign I described above, as shown in FIG. 4. In other words, the shape of the transmittable portion 341a is a shape of an equal sign-shaped figure indicating the location of the touch switch TS, and symbols or letters indicating the role of the touch switch TS, such as "FUNCTION”. The base layer 341 is formed, for example, by applying a die-cut print in the shape of a transmittable portion 341a under the first coloring layer 342, for example, with an ink whose transmittance of visible light is less than a predetermined threshold value (ink of black or dark gray or other color, whose brightness is less than a predetermined threshold value). In other words, the base layer 341 transmits the light emitted from below by the light emitter 32 into the shape of the sign I.

When the color of the first coloring layer 342 is a bright color such as white, the base layer 341 preferably has a two-layer structure consisting of a first base layer 3411 and a second base layer 3412, as shown in FIG. 4. The first base layer 3411 is provided above the second base layer 3412 and is a brighter color than the second base layer 3412. For example, the first base layer 3411 can be light gray and the second base layer 3412 can be black or dark gray. This prevents the color of the first coloring layer 342 from appearing darker than the color of the base portion 341b of the base layer 341 when viewed from above when the first coloring layer 342 is a bright color. If the color of the first coloring layer 342 is a low brightness color such as black or dark gray, the base layer 341 can be composed of only the second base layer 3412.

On the top side (top surface side) of the diffuse reflection layer 343 is a second coloring layer 344. The second coloring layer 344 is shaped in the shape of sign I in plan view, as shown in FIG. 4, and is formed by being printed on top of the diffuse reflection layer 343, for example. The second coloring layer 344 is not limited to printing as long as it colors over the diffuse reflection layer 343.

The color of the second coloring layer 344 is preferably in substantially the same color as the first coloring layer 342. The substantially same color is a color that is generally considered difficult for humans to perceive a difference, such as a color where the color difference between two colors is less than a predetermined threshold, and does not have to be exactly the same color. By making the color of the second coloring layer 344 substantially the same color as that of the first coloring layer 342, the sign I can be made invisible when the power is off (when the light emitter 32 is not emitting light), thereby enhancing the design.

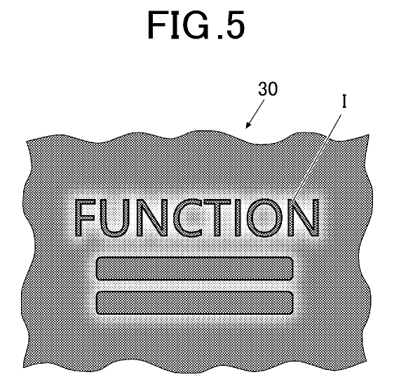

The second coloring layer 344 is formed so that it is positioned inside the transmittable portion 341a (white-colored portion) of the base layer 341 in plan view. For example, if the sign I is letters, the letters shaped in the second coloring layer 344 are thinner than the letters shaped in the transmittable portion 341a of the base layer 341. As a result, when the electronic keyboard instrument 1 is turned on and the light emitter 32 is emitting light, the light from the light emitter 32 illuminates the area around the sign I in the second coloring layer 344 through the transmittable portion 341a, the first coloring layer 342 and the diffuse reflection layer 343, so that the sign I appears and can be displayed in such a way that it is easily visible to the user as shown in FIG. 5.

As described above, an operation panel 30 of an electronic keyboard instrument 1 includes: a base layer 341 including a transmittable portion 341a that transmits visible light and is shaped in a shape of a sign I, and a base portion 341b that surrounds the transmittable portion 341a and has a lower transmittance of visible light than the transmittable portion 341a; a first coloring layer 342 that is on a layer above the base layer 341, is colored by a certain color, and transmits at least part of visible light; a diffuse reflection layer 343 that is on a layer above the first coloring layer 342 and diffusely reflects at least part of visible light; and a second coloring layer 344 that is formed on a layer above the diffuse reflection layer 343 and in plan view from above, formed inside the shape of the sign I of the transmittable portion 341a. Therefore, it is possible to provide an operation panel 30 that looks good because fingerprints are inconspicuous and has good visibility of sign I such as letters, figures, and symbols when illuminated from below.

For example, the second coloring layer 344 is shaped to correspond to the sign I in plan view from above and is formed inside the shape of the sign I of the transmittable portion 341a. Thus, the visibility of the sign I when illuminated from below can be improved.

For example, the sign I is letters, and the letters shaped in the second coloring layer 344 are thinner than the letters shaped in the transmittable portion 341a of the base layer 341. Therefore, when illuminated from below, the second coloring layer 344 can make the letters of the sign I appear, thus improving the visibility of the sign I.

The first coloring layer 342 and the second coloring layer 344 are formed in substantially the same color as each other. Therefore, the second coloring layer 344 can be made invisible when the electronic keyboard instrument 1 is turned off, providing an even better looking operation panel 30.

The operation panel 30 has a light emitter 32 provided lower than the base layer 341 and emits light. Therefore, it is possible to provide an operation panel 30 with good visibility.

The operation panel 30 is equipped with a detector 33 that detects the contact or proximity of a user's finger on a lower layer than the base layer 341. Thus, user touch operation can be detected.

The description in the above embodiment is a suitable example of an embodiment for the present disclosure and the present disclosure is not limited thereto. For example, in the above embodiment, the case in which the operation panel 30 as the panel of the present disclosure is provided in an electronic keyboard instrument 1 is described as an example, but the panel to which the present disclosure is applied is not limited to electronic keyboard instruments and may be installed in other electronic musical instruments or electronic devices.

In the above embodiment, the second coloring layer 344 is formed on a layer above the diffuse reflection layer 343, but the second coloring layer 344 may be formed inside the diffuse reflection layer 343. For example, a second coloring layer 344 may be sandwiched between two diffuse reflection layers 343.

Other details of the configuration and operation of the operation panel 30 can also be changed as needed without departing from the intent of the present disclosure.

Although some embodiments of the present disclosure have been described and illustrated in detail, the scope of the present disclosure is not limited to the disclosed embodiments, and should be interpreted by terms of the appended claims. Furthermore, equivalents that involve changes unrelated to the essence of the present disclosure as described in the claims are also included within the scope of the present disclosure.

1. A panel comprising:
a base layer including a transmittable portion that transmits visible light and is shaped in a shape, and a base portion that surrounds the transmittable portion and has a lower transmittance of visible light than the transmittable portion;
a first coloring layer that is on a layer above the base layer, is colored by a color, and transmits at least part of visible light;
a diffuse reflection layer that is on a layer above the first coloring layer and diffusely reflects at least part of visible light; and
a second coloring layer that is formed on a layer above the diffuse reflection layer or inside the diffuse reflection layer and, in plan view from above, formed inside the shape.

2. The panel according to claim 1, wherein
the second coloring layer is shaped corresponding to the shape in plan view from above, and is formed inside the shape of the transmittable portion.

3. The panel according to claim 2, wherein
the shape is a shape of a letter, and
a letter shaped in the second coloring layer is thinner than the letter shaped in the transmittable portion.

4. The panel according to claim 1, wherein
the second coloring layer is colored by a same color as the color of the first coloring layer.

5. The panel according to claim 1, further comprising
a light emitter that is provided below the base layer and emits light from below the base layer.

6. The panel according to claim 1, further comprising
a detector that is provided on a lower layer than the base layer, and detects contact or proximity of a user's finger.

7. An electronic musical instrument comprising:
a panel that includes:
a base layer including a transmittable portion that transmits visible light and is shaped in a shape, and a base portion that surrounds the transmittable portion and has a lower transmittance of visible light than the transmittable portion;
a first coloring layer that is on a layer above the base layer, is colored by a color, and transmits at least part of visible light;
a diffuse reflection layer that is on a layer above the first coloring layer and diffusely reflects at least part of visible light; and
a second coloring layer that is formed on a layer above the diffuse reflection layer or inside the diffuse reflection layer and, in plan view from above, formed inside the shape; and
multiple performance operators.

8. The electronic musical instrument according to claim 7, wherein
the second coloring layer is shaped corresponding to the shape in plan view from above, and is formed inside the shape of the transmittable portion.

9. The electronic musical instrument according to claim 8, wherein
the shape is a shape of a letter, and
a letter shaped in the second coloring layer is thinner than the letter shaped in the transmittable portion.

10. The electronic musical instrument according to claim 7, wherein
the second coloring layer is colored by a same color as the color of the first coloring layer.

11. The electronic musical instrument according to claim 7, further comprising
a light emitter that is provided below the base layer and emits light from below the base layer.

12. The electronic musical instrument according to claim 7, further comprising
a detector that is provided on a lower layer than the base layer, and detects contact or proximity of a user's finger.

13. An electronic device comprising a panel that includes:
a base layer including a transmittable portion that transmits visible light and is shaped in a shape, and a base portion that surrounds the transmittable portion and has a lower transmittance of visible light than the transmittable portion;
a first coloring layer that is on a layer above the base layer, is colored by a color, and transmits at least part of visible light;
a diffuse reflection layer that is on a layer above the first coloring layer and diffusely reflects at least part of visible light; and
a second coloring layer that is formed on a layer above the diffuse reflection layer or inside the diffuse reflection layer and, in plan view from above, formed inside the shape.

14. The electronic device according to claim 13, wherein
the second coloring layer is shaped corresponding to the shape in plan view from above, and is formed inside the shape of the transmittable portion.

15. The electronic device according to claim 14, wherein
the shape is a shape of a letter, and
a letter shaped in the second coloring layer is thinner than the letter shaped in the transmittable portion.

16. The electronic device according to claim 13, wherein
the second coloring layer is colored by a same color as the color of the first coloring layer.

17. The electronic device according to claim 13, further comprising
a light emitter that is provided below the base layer and emits light from below the base layer.

18. The electronic device according to claim 13, further comprising
a detector that is provided on a lower layer than the base layer, and detects contact or proximity of a user's finger.
